(19) United States
(12) Patent Application Publication
(10) Pub. No.: US 2013/0173235 A1
(43) Pub. Date: Jul. 4, 2013

(54) PREDICTION OF POST-PROCEDURAL APPEARANCE

(71) Applicant: Simon Freezer, Springfield (AU)

(72) Inventor: Simon Freezer, Springfield (AU)

(73) Assignee: MY ORTHODONTICS PTY LTD, Morphett Vale, SA (AU)

(21) Appl. No.: 13/699,033

(22) PCT Filed: May 20, 2011
(86) PCT No.: PCT/AU2011/000598

§ 371 Date: Mar. 4, 2013

(30) Foreign Application Priority Data
May 21, 2010 (AU) 2010902221

(51) Int. Cl. G06F 19/00

(52) U.S. Cl. CPC G06F 19/3437
USPC 703/2; 703/11; 707/790

(57) ABSTRACT

The present invention relates to a method of predicting appearance after undergoing a medical procedure. The present invention may be utilised to assist a patient in deciding whether to undergo a procedure, or in selecting a particular procedure to produce a desired post-procedural appearance. The present invention identifies one or more precedent cases, where the same or a similar procedure was performed. These precedent cases are then analysed to calculate an observed change for each precedent case. The observed changes are then averaged to produce a final change function. This change function can then be applied to a pre-procedural model of the relevant body part of the patient, to produce a predicted post-procedural model of the patient's body part. In this way, the post-procedural appearance of the body part can be accurately predicted, based on a statistical analysis of historical data.

### FIELD OF THE INVENTION

The present invention relates to the field of medical procedures, such as plastic surgery or orthodontic procedures, which may alter the appearance of a body part. For convenience, particular reference will be made throughout this specification to the modelling of a person's face. However, the present invention has broader application.

### FIELD OF THE INVENTION

This application claims priority from Australian provisional application No 2010902221 entitled “Prediction of Post-Procedural Appearance,” the entire contents of which are hereby incorporated by reference.

### BACKGROUND OF THE INVENTION

Many medical procedures alter a person's appearance. Some procedures do this incidentally, whilst other procedures are performed specifically to favourably alter the person's appearance. In both eases, however, a person is likely to be interested in the change that may occur to their appearance, and in many circumstances this will influence their decision as to whether to have a procedure performed, or which procedure, (among different options) to have performed. This is particularly true in relation to operations which may alter the appearance of a person's face.

Three-dimensional facial modelling software exists, which can be used to produce a computer model of a person's face—taking as input, for example, a set of two dimensional images of the face, taken from various different angles. However, whilst it is relatively simple to use these software tools to produce a facial model of a person at any given time, from photographs, it is not so simple to predict (ahead of time) changes in appearance that might be caused as a result of a medical procedure.

One approach, for procedures which modify a person's bone structure, is to produce a hard tissue model (e.g. a, computer model of bone structure) for the relevant body part. Then, a user of the software can modify this hard tissue model in accordance with the operation to be performed (for example, realigning a jaw bone).

Once the post-operation hard tissue has been modelled, another model can be applied to predict the behaviour and deformation of soft tissue, based on the resulting bone structure. This allows the person's post-operative external appearance to be predicted.

Such an approach can be found in Mathematics in Facial Surgery, Deuflhard et al, Notices of the American Mathematical Society, Volume 53, No 9, October 2006. Similar approaches may be used for procedures which insert implants into the relevant body part—for example, mass spring models are often used in computer graphics and computer animation, although (as Deuflhard points out) they tend to sacrifice “numerical stability and approximation quality”.

However, such an approach requires sophisticated scanning equipment in order to accurately model the person's bone structure. Furthermore, the accuracy of its prediction is heavily dependent on the accuracy and applicability of the soft tissue model (which may be quite computationally complex), and on how accurately the user predicts the modifications to the hone structure that result from the procedure. Both of these factors cause difficulties in the accurate and cost-effective prediction of post-operative appearance.

It is an object of the present invention to reduce or ameliorate some or all of the above difficulties, or at least to provide an alternative to existing ‘methods’ of predicting post-procedural appearance.

### SUMMARY OF THE INVENTION

According to a first aspect of the present invention, there is provided a method of predicting visual appearance of a body part, after a procedure, comprising:
generating a pre-procedural model of the body pail;
identifying One or more precedent cases for, the procedure; and
generating a predicted post-procedural model of the body part, based on the one or more precedent cases.

The post-procedural model may be generated based on statistical analysis of the one or more precedent cases. In particular, the post-procedural model may be generated by:
calculating a change function correlating to the change observed in the'one or more precedent cases; and
applying the change function to the pre-procedural model.

The term “change function” is used within this specification to broadly cover any description of a change or difference between two models. The exact format of the change function will depend on the format of the models used. For example, where the models comprise a plurality of numerical values, each value representing the position of a point on the body part, then the change function may comprise a matrix or array of the differences in these numerical values, for each position.

The change function may be calculated by:
generating a precedent pre-procedural model for each precedent case;
generating a precedent post-procedural model for each precedent case;
for each precedent case, comparing the precedent preprocedural model to the precedent post-procedural model, to produce an intermediate change function for each precedent case; and
averaging the intermediate change functions to calculate the change function.

The term “intermediate” is used to distinguish the change function produced for a specific precedent case from the final change function used to predict the visual appearance of the body part, post-procedure.

The term “average” in this specification includes a wide variety of ‘averaging’ functions, and should not be restricted to purely the mean of a data set. It may, for example, also include the median of a data set, or a weighted average.

In a second aspect of the present invention, there is provided a method of assisting a person to select a procedure comprising:
generating a pre-procedural model of the body part;
modifying the pre-procedural model to specify a desired post-procedural appearance of the body part;
identifying one or more suggested procedures which arc most likely to produce the desired post-procedural appearance, based on one or more precedent cases.

The step of modifying the pre-procedural model may comprise measuring a change from the pro-procedural model to the post-procedural appearance, and the step of identifying one or more suggested procedures may comprise:
searching a database of precedent cases to identify one or more precedent cases which resulted in a similar change; and
determining the procedure performed in the one or more precedent cases.

Alternatively, the step of identifying one or more suggested procedures may comprise:
searching a database containing procedures having associated appearance changes, the associated appearance changes being generated from the one or more precedent cases; and
identifying a procedure with an associated appearance change similar to the desired change.

In a third aspect of the present invention, there is provided a method of predicting an expected change in appearance of a body part, as a result of a procedure, comprising:
identifying one or more precedent cases from a database, each precedent case comprising data relating to a pre-procedural appearance and a post-procedural appearance of the body part; and
from the data for each precedent case, calculating a modifier defining the change from the pre-procedural appearance to the post-procedural appearance of the body part, whereby the calculated modifier indicates the expected change to the body part as a result of the procedure.

In a fourth aspect of the present invention, there is provided a method of determining a change function associated with a procedure affecting the appearance of a body part, the change function representing a change from a pre-procedural appearance to a post-procedural appearance of the body part, the method comprising:
identifying one or more precedent cases of the procedure;
obtaining data for each precedent case, the data comprising information relating to a pre-procedural appearance and a post-procedural appearance of the body part; and
from the data, comparing the pre-procedural and post-procedural appearance of the body part, for each precedent case; and
calculating a change function defining an observed change from the pre-procedural appearance to the post-procedural appearance of the body part, for the one or more precedent cases.

In a fifth aspect of the present invention, there is provided a method of correlating a medical procedure with a change in a data set, the data set corresponding to the appearance of a body part, file method comprising:
analysing one or more precedent cases of the procedure; to determine a change associated with the procedure.

In a sixth aspect of the present invention, there is provided a system for predicting visual appearance of a body part, after a procedure, comprising:
means for generating a pre-procedural model of the body part;
means for identifying one or more precedent cases of the procedure;
means for generating a post-procedural model of the body part, based on the one or more precedent cases.

In a seventh aspect of the present invention, there is provided a system for predicting a visual appearance of a body part, after a procedure, comprising:
a processor configured to perform any one of the methods described above; and
a memory in communication with the processor.

The system may further comprise a display to display the predicted appearance of the body part, after the procedure.

The term procedure in this specification may include a wide variety of medical procedures or treatment regimes that may affect appearance of a body part, including plastic surgery procedures, maxillo-facial or cranio-facial procedures, and orthodontic procedures.

The present invention can be applied to the appearance of a wide range of body parts, including both single contiguous structures (such as faces and single element body parts), as well as body parts that are constructed from more than one element, such as the mouth and dental apparatus.

According to a further aspect of the present invention, there is provided a computer program product, comprising a computer usable medium having a computer readable program code embodied therein, said computer readable program code adapted to be executed to implement the steps of any one of the above methods.

According to a further aspect of the present invention, there is provided a database comprising:
a plurality of procedure identifiers, each identifier associated with a medical procedure which can be performed on a body part; and
a change function associated with each procedure identifier, indicating a predicted appearance change to the body part, caused by undergoing the associated medical procedure.

According to a further aspect of the present invention, there is provided an apparatus adapted to perform the preceding method. Yet further aspects of the present invention will be revealed throughout this specification.

A detailed description of one or more embodiments of the invention is provided below along with accompanying figures that illustrate by way of example the principles of the invention. While the invention is described in connection with such embodiments, it should be understood that the invention is not limited to any embodiment. On the contrary, the scope of the invention is limited only by the appended claims and the invention encompasses numerous alternatives, modifications and equivalents. For the purpose of example, numerous specific details are set forth in the following description in order to provide a thorough understanding of the present invention.

The present invention may be practiced according to the claims without some or all of these specific details. For the purpose of clarity, technical material that is known in the technical fields related to the invention has not been described in detail so that the present invention is not unnecessarily obscured.

### BRIEF DESCRIPTION OF THE DRAWINGS

An illustrative embodiment of the present invention will be discussed with reference to the accompanying drawings wherein:

FIG. 1 depicts photographs of a person prior to undergoing a procedure;

FIG. 2 depicts an exemplary facial model;

FIG. 3 is a general diagram of a computer architecture which could be used to implement the present invention;

FIG. 4 is a flow chart of a method according to an embodiment of the present invention;

FIG. 5 is a flow chart of the step of analysing precedent cases shown in FIG. 4;

FIG. 6 is a flow chart of a method according to an alternative embodiment of the present invention;

FIG. 7 depicts photographs of another person prior to undergoing a procedure;

FIG. 8 depicts a facial model derived from the photographs of FIG. 7;

FIG. 9 depicts photographs of the person of FIG. 7, after undergoing a procedure;

FIG. 10 depicts a facial model derived from the photographs of FIG. 9; and

FIG. 11 is a table showing a mathematical representation of the facial models of FIGS. 8 and 10, along with a change function derived from these facial models.

In the following description, like reference characters designate like or corresponding parts throughout the several views of the drawings.

### DETAILED DESCRIPTION

The present invention will herein be described with particular reference to an orthodontic application. However, this is for exemplary purposes only, and the present invention has wider application.

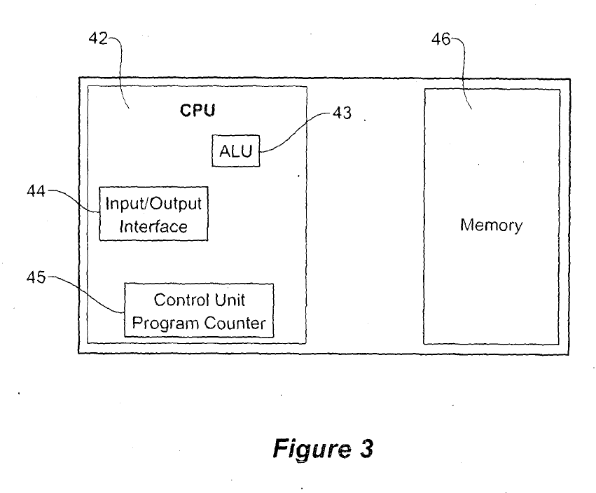

The present invention will typically be performed using a computer—FIG. 3 schematically and generally depicts hardware that may be used for accessing and using the electronic document according to an embodiment of the present invention. A central processing unit (CPU) 42, containing an Input/Output Interface 44, an Arithmetic and Logic Unit (ALU) 43 and a Control Unit and Program Counter element 45 is in communication with input and output devices through the Input/Output Interface 44, and a memory 46.

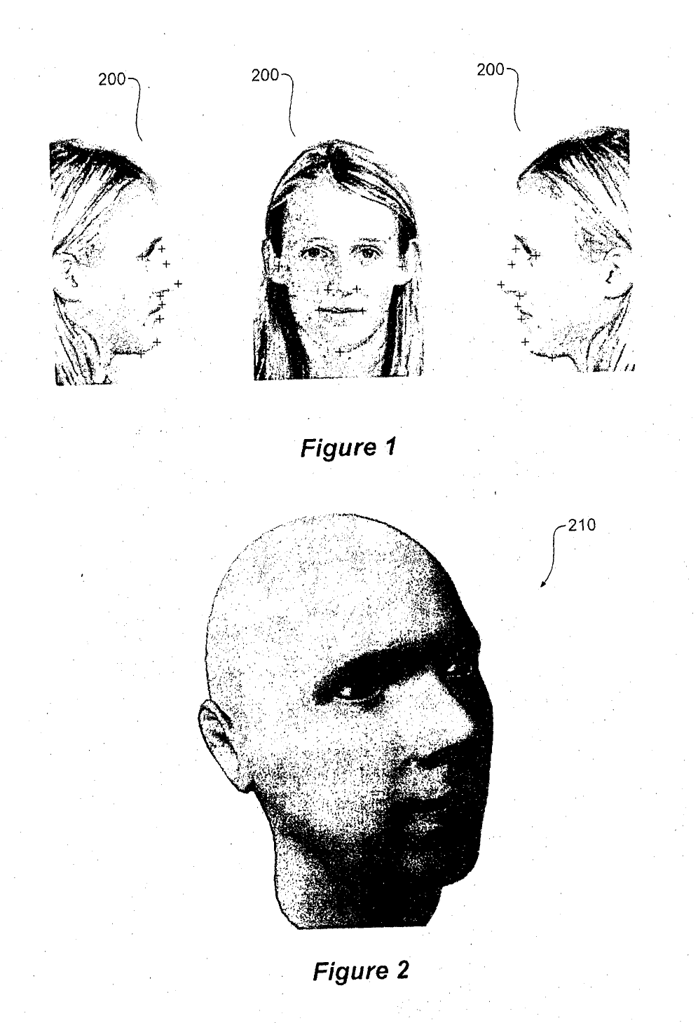

Referring now to FIG. 1, three photographs 200 of a woman's face are shown, from different angles. These images 200 can be loaded into facial modelling software (or software implementing the present invention, and incorporating the facial modelling software). As shown in FIG. 1, cross marks can be placed on the images 200, to mark key points on the face. The images 200 can then be used to produce a three-dimensional facial model 210 of the woman's face, from the photographs 200.

An exemplary facial model 210 can be found in FIG. 2. Such a model 210 will typically contain a large number of data points, each data point specifying a relevant portion of the face, and each data point contains spatial information (e.g. x, y, z co-ordinates) that places the relevant facial feature at a specific position in three-dimensional space.

There are of course, a variety of tools to generate a three-dimensional facial model from two-dimensional images, and these may define details of the facial model in a wide range of formats. To give a brief overview of methods employed by some tools, a generic base facial model may be used, which may correspond to an observed ‘average’ human face. Cross marks (as shown in FIG. 1) can be placed on the photograph, to identify key positions on the face—for example, the corners of the mouth, eyes and nose, which helps initiate the parameter estimation process. The generic model can then, firstly, be altered to conform to the markings. Subsequent analysis of the image, such as line or shading analysis, can then be performed to further alter the model to match the face of the patient.

The number of data points represented in the model may also vary widely, depending on the modelling tool, and also on the body part being modelled (more complex body parts may require more data points). Similarly, the format of the data points may also vary. One simple way of defining a facial model is a set of values:

S=(X1,Y1, Z1, . . . , Xn, Yn, Zn) [symbol] R³ⁿ

where S is a set of data points defining spatial segments of a face.

The model may further comprise textural data points, indicating the texture at different points across the face. However, rather than storing x, y and z co-ordinates, the data points may specify a variation from the population average (or from the generic model), as a measure of standard deviations or other units along a predetermined line. Of course, it will be appreciated that the present invention is applicable independently of the specific modelling tool or model format used, and is not limited to any particular tool or format.

Referring now to FIG. 3, the photographs 200 shown in FIG. 1 may he taken 100 before the procedure, and may be used to generate 110 a pre-procedural model 210 other face. However, if this woman is contemplating undergoing an orthodontic procedure, she is likely to be interested in her appearance after undergoing the procedure.

Accordingly, according to this embodiment of the present invention, an historical database 300 is consulted. In this embodiment, the historical database 300 contains clinical details of cases for a range of different procedures, and a range of different patients. Each entry in the database 300 may contain details of the procedure performed, as well as details of the appearance of the patient both before and after undergoing the procedure. This may include, for example, photographs 200 as shown in FIG. 1 (for pre-procedural appearance), and the equivalent photographs taken after the procedure has been completed. The database 300 may contain a range of other clinical details, including a patient's clinical history, treatment details, descriptive text, and demographic information. The database 300 may also be categorised by practitioner, or alternatively, each practitioner may maintain his or her own historical database 300.

In consulting the historical database 300, one or more precedent cases 220 may be identified 120—that is, cases where the same or a similar procedure was performed on a similar patient. Preferably, multiple precedent cases 220 are identified 120.

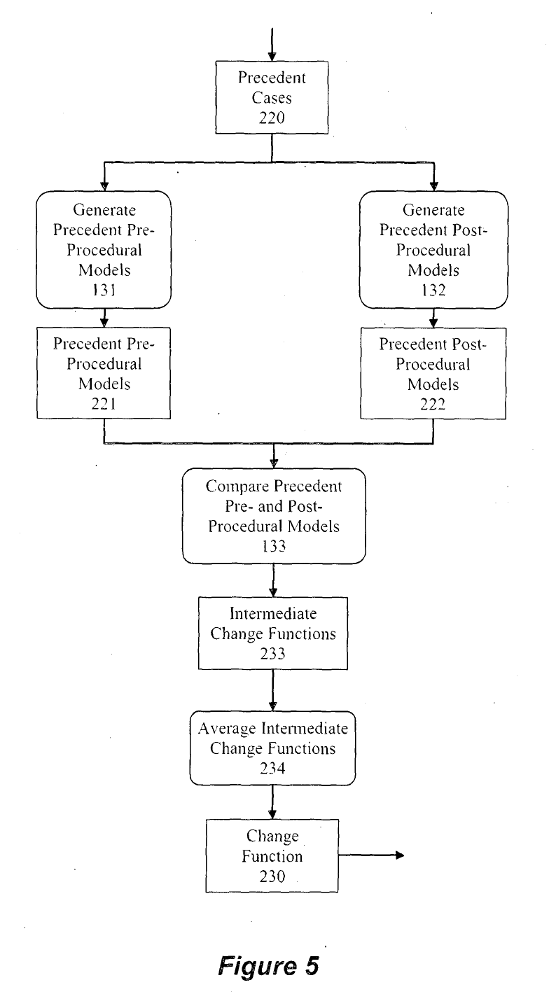

Then, for each precedent case 220, the difference between the patient's appearance before and after the procedure is analysed 130. One way of analysing the patient's appearance, as shown in FIG. 5, would be to produce two three-dimensional facial models 221, 222 for each precedent case 220—generating 131 one model for their appearance before the procedure (pre-procedural model 221), and the other for their appearance after the procedure (post-procedural model 222). Then, the differences between the pre-221 and post-procedural model 222 can he analysed—for instance, each data point in the pre-procedural model 221 could he compared to the corresponding data point in the post-procedural model 222, to see how its spatial co-ordinates change from the pre-procedural model 221 to the post-procedural model 222. In this way, a change function 230 can be produced, describing the change that is applied 15, to the pre-procedural model, to produce the post-procedural model.

If multiple precedent cases 220 have been identified, an intermediate change function 233 may be produced for each precedent case 220, and the intermediate change functions can'then be averaged 234 in order to produce a resulting change function 230. The term “average” in this context is intended to refer to a variety of analysis methods. The “average” may be a simple mean of the changes to be applied to each data point, for each precedent case. Alternatively, the median, a modified mean (for example, after excluding outliers) or a weighted average may be used in accordance with the present invention. For example, in some embodiments, a user may emphasise particular cases to-be of greater weight, as they are more recent cases, or relate to more similar procedures, or relate to more similar patients. These weights may be used when averaging 234 intermediate change functions 233 to produce a weighted average.

Once the change function 230 is calculated for, the precedent case(s), it is then applied 140 to the pre-procedural model 210 of the current patient's face. Accordingly, each data point in the pre-procedural a model 210 is adjusted by the amount specified in the change function 230, to produce a predicted post-procedural model 240 of the current patient's face, which can be displayed 150 to a user. The predicted post-procedural model 240 can be presented to the patient, to help them decide whether to proceed with the procedure.

Of course, the predicted post-procedural appearance can be displayed in a number of ways. One option would be to display the post-procedural model 240 as described above.

Alternatively, the post-procedural model 240 could be converted to a series of two-dimensional images for publication in electronic form such as email, publishing as a PDF document, posting to the Internet or storage on a removable storage medium such as a CD, DVD, etc, as well as inhard copy form for paper-based correspondence in pictorial presentations.

One other alternative for displaying post-procedural appearance would be translating the post-procedural model back to a two-dimensional representation, by manipulating the original two-dimensional photographs 200 to match the predicted changes in accordance with the predicted post-procedural model 240.

The display may also allow for other models, and for models of other devices, (e.g. models of implants, internal bone structures, teeth, etc) to be displayed concurrently with and/or superimposed upon the pre- or predicted post-procedural models.

It will he understood that the information stored in the database 300 can vary considerably between different embodiments of the invention. In some cases, rather than pre- and post-procedural photographs, the database may contain pre- 221 and post-procedural 222 models of the present invention associated with each case, which will avoid the need for software to generate these models each tune the database 300 is queried.

In another example, the database 300 may store a change function 230 associated with each procedure, and/or with a particular category of patient, and/or with a particular practitioner, which can be retrieved on request, and applied to a pre-procedural model 210.

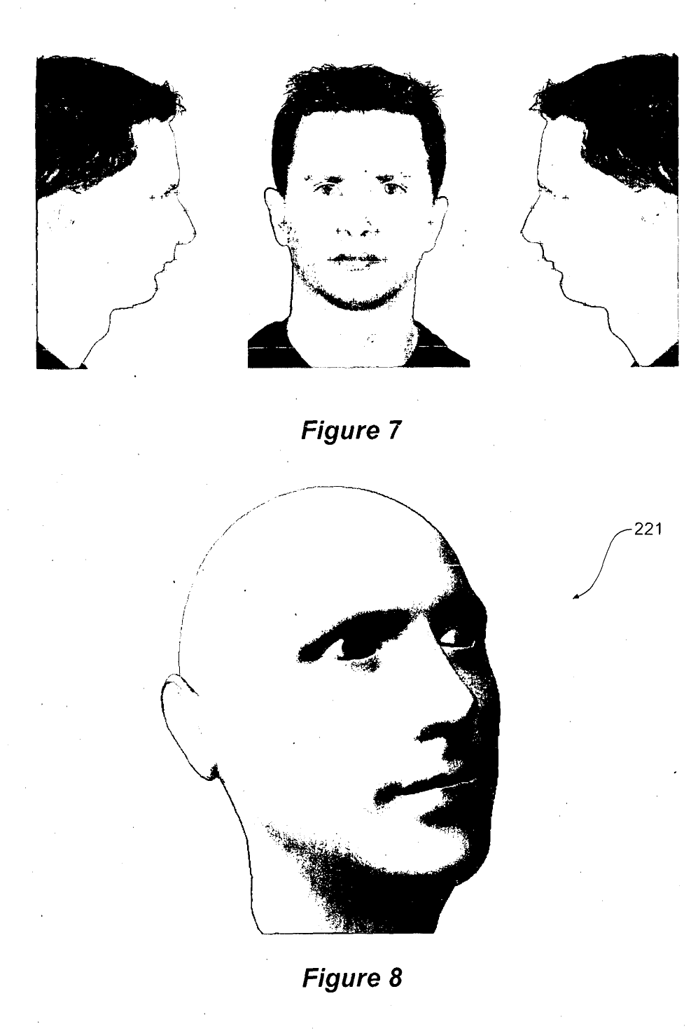

By way of (non-limiting) example, FIGS. 7 to 11 depict how a simple change function might be derived, from analysis of a single precedent case 220. In FIG. 7, pre-procedural photographs of a patient, being a precedent case 220, are depicted, with cross marks to define key features of the patient's face. These photographs can be used to generate a pre-procedural model 221 of the precedent case 220, as shown in FIG. 8.

It should be noted that, to simplify further analysis, it is preferable that the photographs are standardised to a significant degree. That is the photographs are preferably taken consistently from the same angles, and ideally from the same distance or with a compensating degree of magnification. This may be accomplished by various different means of directing or assisting the person taking the photograph. For a facial model, one way of standardising photographs would he to shine cross-hairs onto the person's face, and direct the photographer to position the cross-hairs at predetermined positions on the face—e.g. at the tip of the nose, the corner of the mouth or the bottom of the ear.

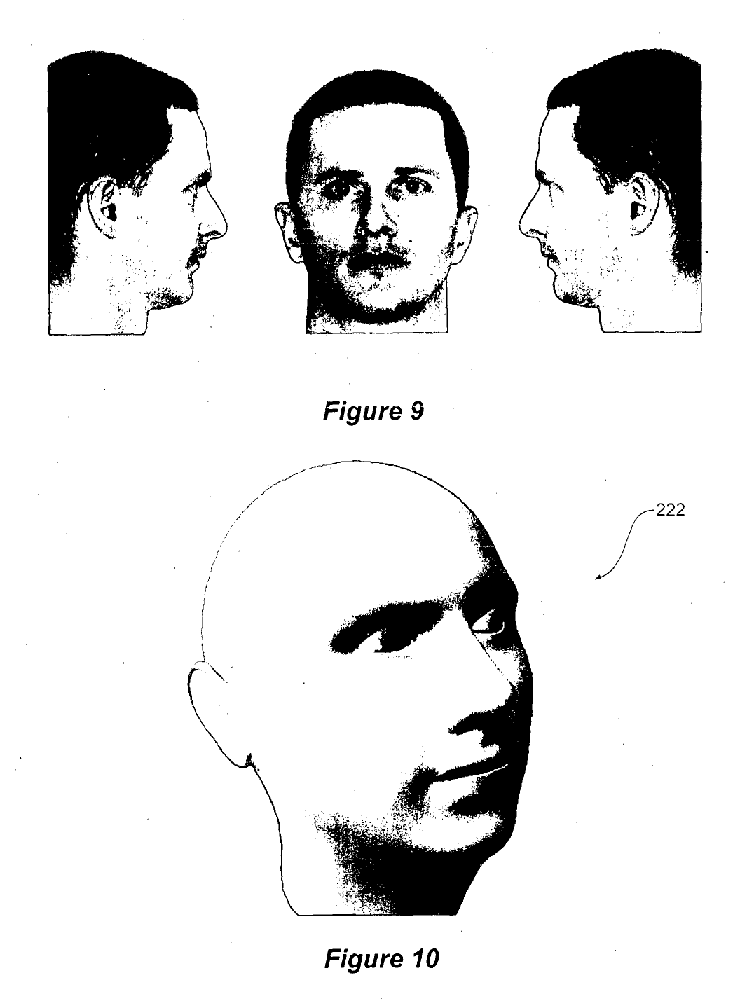

Following treatment, further photographs can be taken of the patient, as shown in FIG. 9. These photographs can then he used to generate a post-procedural model 222 of the precedent case 220.

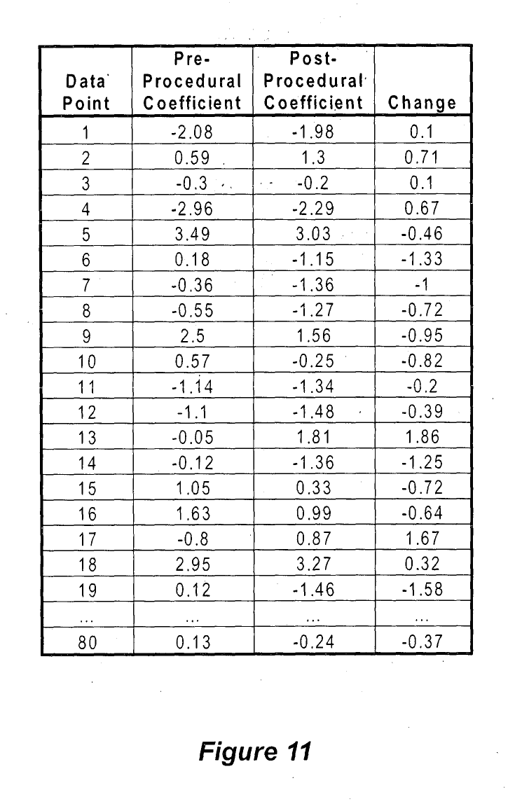

FIG. 11 is a table, depicting how the pre- 221 and post-procedural 222 models may be stored by the software program. The models 221,222 may each be represented by a series of 80 data points, each data point corresponding to a particular part/segment of a person's face.

Each of the 80 data points has an associated value, which defines the spatial position of that part on the person's face. The position in this example is defined by a single number, indicating the position of that part relative to its position in the average or generic human face—e.g. the number of standard deviations along a predetermined line.

A simple change function 230 can then be determined by subtracting the values for the pre-procedural model 221 from the values for the post-procedural model 222. The change function 230 can be applied to models for new patients (to produce a predicted post-procedural model 240) simply by adding the changes observed to each data point for the precedent case 220 to the values of corresponding data points in a pre-procedural model 210 for the new patient.

The predicted post-procedural model 240 is therefore produced from actual historical examples of the particular procedure performed. Unlike the prior art, the present invention can provide an indication of the likely overall result of a procedure, without requiring the use of sophisticated scanning equipment to produce hard tissue models, without requiring the manipulation of the hard tissue model to simulate the procedure to be performed, and without requiring the use of mass spring models to predict the patient's resulting appearance. It is not reliant, for example, on a surgeon accurately predicting the change in bone structure as a result of his intervention. Similarly, it is not reliant on the accuracy of amass spring model which may not account for all the factors involved in producing the patient's final post-procedural appearance. Rather, the present invention is able to predict appearance based simply on a statistical analysis of similar precedent cases.

Accordingly, for best results, the precedent cases used are preferably as closely matched to the present case as possible. To this end, the database preferably stores clinical details such as age, sex, race etc, which may be relevant to predicting appearance. In such a case, ideally the precedent cases 220 used will be historical examples of the same procedure, performed by the same practitioner, and on the same type of patient (e.g. of similar age, race and with similar clinical and treatment histories and clinical features). More recent cases may also be preferred, so that changes in a practitioner's techniques are monitored. On the other hand, the statistical analysis used by the present invention is likely to be most meaningful if more precedent cases are used.

Accordingly, a software program implementing the present invention may provide partial user control of the selection of precedent cases. For example, for a particular patient, the program may search a database for past cases which produce an exact match for a number of features—for example, cases involving the same procedure, performed on a person of the same sex and race, and in the same age range). It may also search for other similar cases which match some of the features—for example, it may identify other cases which are for the same procedure, performed on a person of the same sex and race, but in a different age range. It may present the user with a selection of cases retrieved from the database 300, along with an indication of their relevance, and prompt the user to select which cases to use as precedents when predicting the patient's post-procedural appearance. The user can accordingly select which of the cases presented to them are to be used as precedents. These are, of course, non-limiting examples provided only as an indication of possible variations within the scope of the present invention, and various other database searching methodologies may be employed.

The number of precedent cases 220 selected may vary. In some circumstances, only one precedent case 220 could be used. However, a prediction produced from such limited data may be subject to errors due to lack of sufficient information. Accordingly, more precedent cases 220 will generally be desired. The number of precedent cases 220 can vary depending on their availability, the particular procedure, and the clinical accuracy required.

Another application of the present invention is in the selection of procedures (e.g. orthodontic treatments) for a patient. For example, predicted post-procedural models 240 could be produced for a variety of possible procedures, and these could be presented to the patient along with other details of the possible procedures. The predicted appearance could then be a factor in selecting which treatment option to pursue.

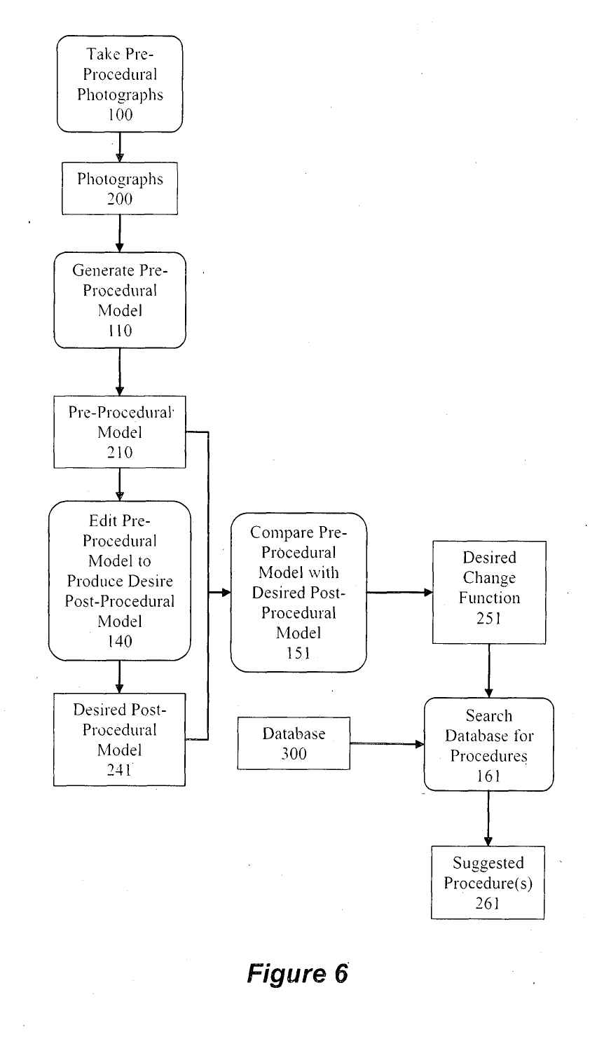

Another alternative application of the present invention is depicted in FIG. 6. As described previously, photographs 200 of the patient may be taken 100 prior to treatment, and a pre-procedural model 210 may he generated. However, in this example, the pre-procedural model 210 may be a morphable facial model, which can be edited or ‘morphed’, in accordance with the patient's requests or the practitioner's suggestions, to produce a desired post-treatment appearance, shown in a desired post-procedural model 241. The desired post-procedural model 241 can then be compared to the pre-procedural model 210, to produce a desired change function 251. The database 300 can then be queried 161 (preferably with other criteria specifying other desired post-treatment outcomes) to identify procedures 261 which are likely to produce a post-procedural appearance that most closely matches the desired appearance (i.e. to identify procedure(s) 261 which are most closely correlated with the desired change function 251).

Various database searching methodologies could be employed in order to select the most relevant procedures. Cluster analysis is one example of a searching methodology that may be applicable, which includes, many types of pattern matching and classification algorithms that rely on similarities in data being found and grouped. K-means clustering, for example, is used in unsupervised neural network learning, and may be applicable to the present invention. Alternatively, k-nearest neighbour searching may also he useful. However, the skilled person may adopt any appropriate searching methodology within the scope of the present invention.

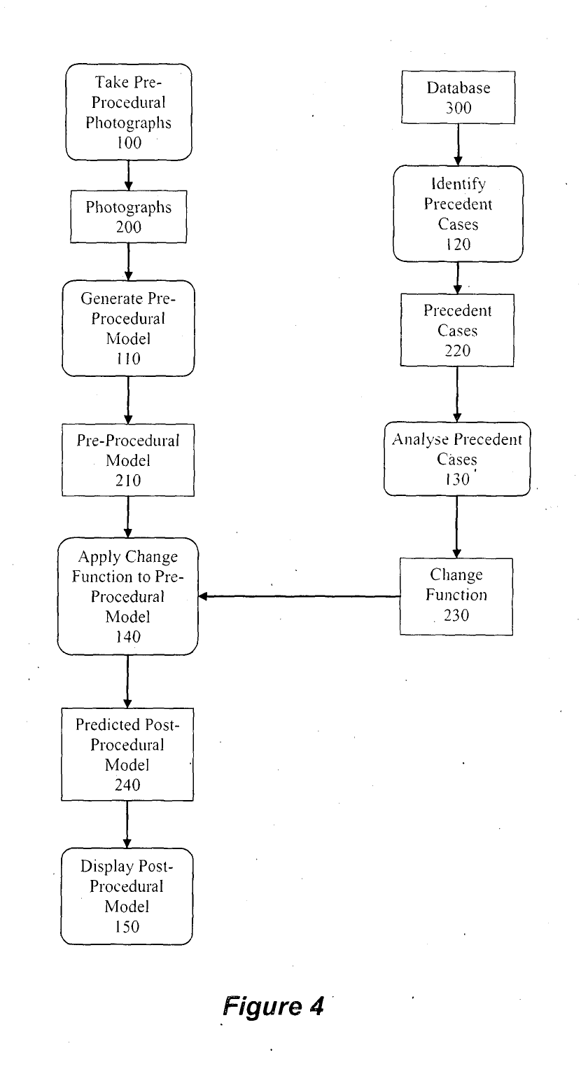

Once suggested procedure(s) have been identified, the embodiment shown in FIG. 4 may be used to show the user their actual predicted appearance after undergoing the procedure. Clearly, the actual predicted appearance may well differ from the desired appearance, even if the suggested procedure(s) are likely, to produce the closest matches.

Obviously, the searching methodology will depend on the information contained in the database 300. For example, where the database 300 contains a plurality of precedent cases having pre- and post-procedural models or photographs, the system may need to analyse the many precedent cases to determine the observed appearance change.

Alternatively, if the database simply contains procedures directly associated with observed appearance changes, then this could easily be looked up to find a procedure associated with the desired appearance change. However, whilst the searching step in such an embodiment may be simpler, it would come with the disadvantage that less information is available (e.g. there may be no specific limitations based on age, race or sex contained in such a database 300). Accordingly, the accuracy of the prediction, the flexibility provided to the practitioner, and the choices of procedures (or combinations of procedures) presented to the patient may be reduced.

Those of skill in the art would understand that information and signals may be represented using any of a variety of technologies and techniques. For example, data, instructions, commands, information, signals, bits, symbols, and chips referenced throughout the above description may be represented by voltages, currents, electromagnetic waves, magnetic fields or particles, optical fields or particles, or any combination thereof.

Those of skill in the art would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The steps of a method or algorithm described in connection with the embodiments disclosed herein may be embodied directly in hardware, in a software module executed by a processor, or in a combination of the two. For a hardware implementation, processing may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. Software modules, also known as computer programs, computer codes, or instructions, may contain a number of source code or object code segments or instructions, and may reside in any computer readable medium such as a RAM memory, flash memory, ROM memory, EPROM memory, registers, hard disk, a removable disk, a CD-ROM, a DVD-ROM or any other form of computer readable medium. In the alternative, the computer readable medium may be integral to the processor. The processor and the computer readable medium may reside in an ASIC or related device. The software codes may be stored in a memory unit and executed by a processor. The memory unit may be implemented within the processor or external to the processor, in which ease it can be communicatively coupled to the processor via various means as is known in the art.

Throughout the specification and the claims that follow, unless the context requires otherwise, the words “comprise” and “include” and variations such as “comprising” and “including” will be understood to imply the inclusion of a stated integer or group of integers, but not the exclusion of any other integer or group of integers.

The reference to any prior art in this specification is not, and should not he taken as, an acknowledgement of any form of suggestion that such prior art forms part of the common general knowledge.

It will he appreciated by those skilled in the art that the invention is not restricted in its use to the particular application described. Neither is the present invention restricted in its preferred embodiment with regard to the particular elements and/or features described or depicted herein. It will he appreciated that the invention is not limited to the embodiment or embodiments disclosed, but is capable of numerous rearrangements, modifications and substitutions without departing from the scope of the invention as set forth and defined by the following claims.

1. A method of predicting visual appearance of a body part, after a procedure, comprising:
generating a pre-procedural model of the body part;
identifying one or more precedent cases for the procedure; and
generating a predicted post-procedural model of the body part, based on the one or more precedent cases.

2. The method of claim 1, wherein the post-procedural model is generated by:
calculating a change function representing the change observed in the one or more precedent cases; and
applying the change function to the pre-procedural model.

3. The method of claim 2, wherein there are a plurality of precedent cases, and the change function is calculated by:
generating a precedent pre-procedural model for each precedent case;
generating a precedent post-procedural model for each precedent case;
for each precedent case, comparing the precedent pre-procedural model to the precedent post-procedural model, to produce an intermediate change function for each precedent case; and
averaging the intermediate change functions to calculate the change function.

4. The method of claim 1, wherein the pre-procedural model is generated from one or more two-dimensional images of the body part.

5. The method of claim 1, wherein the one or more precedent cases are identified by searching a case database.

6. The method of claim 3, wherein each intermediate change function further comprises a plurality of intermediate modifier values, each intermediate modifier value corresponding to a point of a model of the body part.

7. The method of claim 6, wherein the change function comprises a plurality of modifier values, each modifier value corresponding to a point of a model of the body part.

8. The method of claim 7, wherein the averaging comprises taking the mean of the intermediate modifier values to produce the modifier values of the change function.

9. The method of claim 1, further comprising:
displaying the predicted post-procedural model of the body part.

10. The method of claim 4, further comprising:
manipulating the one or more two-dimensional images to conform them to the predicted post-procedural model of the body part.

11. A method of determining a change function associated with a procedure affecting the appearance of a body part, the change function representing a change from a pre-procedural appearance to a post-procedural appearance of the body part, the method comprising:
identifying one or more precedent cases of the procedure;
obtaining data for each precedent case, the data comprising information relating to a pre-procedural appearance and a post-procedural appearance of the body part; and
from the data, comparing the pre-procedural and post-procedural appearance of the body part, for each precedent case; and
calculating a change function defining an observed change from the pre-procedural appearance to the post-procedural appearance of the body part, for the one or more precedent cases.

12. The method of claim 11, wherein there are a plurality of precedent cases, and the change function is calculated by:
for each precedent case, comparing the precedent pre-procedural appearance to the precedent post-procedural appearance of the body part, to produce an intermediate change function for each precedent case; and
averaging the intermediate change functions to calculate the change function.

13. The method of claim 11, wherein the one or more precedent cases are identified by searching a case database.

14. A method of correlating a medical procedure with a change in a data set, the data set corresponding to the appearance of a body part, the method comprising:
analysing one or more precedent cases of a procedure, to determine a change associated with the procedure.

15. The method of claim 14, wherein the data set comprises a model of the body part.

16. The method of claim 14, wherein there are a plurality of precedent cases, and the analysing further comprises:
determining an intermediate change observed for each precedent case; and
averaging the intermediate changes to determine the change associated with the procedure.

17. The method of any one of claim 16, wherein the method further comprises:
using the change associated with the procedure to predict, prior to a patient undergoing the procedure, the predicted appearance of the patient's body part after undergoing the procedure.

18. A method of predicting an expected change in appearance of a body part, as a result of a procedure, comprising:
identifying one or more precedent cases from a database, each precedent case comprising data relating to a pre-procedural appearance and a post-procedural appearance of the body part; and
from the data for each precedent case, calculating a modifier defining the change from the pre-procedural appearance to the desired post-procedural appearance of the body part,
whereby the calculated modifier indicates the expected change to the body part as a result of the procedure.

19. A method of assisting a person to select a procedure comprising:
generating a pre-procedural model of the body part;
modifying the pre-procedural model to specify a desired post-procedural appearance of the body part;
identifying one or more suggested procedures, from a plurality of possible procedures, which are most likely to produce the desired post-procedural appearance, based on one or more precedent cases for the possible procedures.

20. The method of claim 19, wherein the step of modifying the pre-procedural model comprises measuring a desired change from the pre-procedural model to the desired post-procedural appearance, and wherein the step of identifying one or more suggested procedures comprises:
searching a database of precedent cases to identify one or more precedent cases which resulted a similar change to the desired change; and
determining the procedure performed in the one or more precedent cases.

21. The method of claim 19, wherein the step of modifying the pre-procedural model comprises measuring a desired change from the pre-procedural model to the post-procedural appearance, and wherein the step of identifying one or more suggested procedures comprises:
searching a database containing procedures having associated appearance changes, the associated appearance changes being generated from the one or more precedent cases; and
identifying a procedure with an associated appearance change similar to the desired change.

22. The method of claim 1, wherein the procedure is an orthodontic procedure.

23. A system for predicting visual appearance of a body part, after a procedure, comprising:
means for generating a pre-procedural model of the body part;
means for identifying one or more precedent cases for the procedure from a precedent database;
means for generating a post-procedural model of the body part, based on the one or more precedent cases.

24. A system for predicting a visual appearance of a body part, after a procedure, comprising:
a processor configured to perform the method of claim 1; and
a memory in communication with the processor.

25. A system according to claim 24, further comprising a display to display the predicted appearance of the body part, after the procedure.

26. A computer program product, comprising a computer usable medium having a computer readable program code embodied therein, said computer readable program code adapted to be executed to implement the steps of the method of claim 1.

27. A database comprising:
a plurality of procedure identifiers, each identifier associated with a medical procedure which can be performed on a body part; and
a change function associated with each procedure identifier, indicating a predicted appearance change to the body part, caused by undergoing the associated medical procedure.

28. The database of claim 27, wherein the change function can be applied to a pre-procedural model of the body part, to produce a predicted post-procedural model of the body part.

29. (canceled)
